(19) United States
(12) Patent Application Publication
(10) Pub. No.: US 2026/0127876 A1
(43) Pub. Date: May 7, 2026

(54) SYSTEM AND METHOD FOR SUPPLYING POWER TO CONSUMERS IN AN ELECTRICAL POWER LINE NETWORK

(71) Applicant: HERE Global B.V., Eindhoven (NL)

(72) Inventors: Deekshant SAXENA, Navi Mumbai (IN); Senjuti SEN, Amsterdam (NL); Abhishek PANDEY, Amsterdam (NL); Soumyadip MAJUMDAR, Amsterdam (NL); Pratik PATIL, Amsterdam (NL); Ashna KUMAR, Amsterdam (NL)

(21) Appl. No.: 18/874,989

(22) PCT Filed: May 11, 2023
(86) PCT No.: PCT/EP2023/062648

§ 371 Date: Dec. 13, 2024

(30) Foreign Application Priority Data
May 11, 2022 (IN) 202211027214
May 11, 2022 (IN) 202211027215
May 11, 2022 (IN) 202211027216
May 11, 2022 (IN) 202211027217
May 11, 2022 (IN) 202211027218

(51) Int. Cl. G06V 20/10; G06V 20/17

(52) U.S. Cl. CPC G06V 20/182; G06V 20/17

(57) ABSTRACT

The present disclosure provides a system and method for supplying power to consumers in an electrical power line network. The system provides automated integration and networking logic for electrical assets. Further, the system provides consumer indexing in an electrical power-line network and facilitates an integrated drive and drone sensor data collection system for surveying and mapping service providers and consumers. The system generates virtual ground control points (GCP's) to form models of an electrical power-line network or grid extending from power generation sites to the end consumer sites.

### BACKGROUND

Historically, electricity providers have used networks of overhead power lines to deliver electricity to customers/consumers. In many cases, the creation of such electrical networks or power grids, particularly in developing countries where building growth rates can be high, establishing connections to the networks or power grids can be ad hoc and undocumented. Accordingly, electricity providers and/or related mapping service providers face significant technical challenges with respect to automatically mapping electricity delivery networks and/or consumer connections to the networks (e.g., a process referred to as consumer indexing), and documenting assets of the electrical grid.

Therefore, there is a need for advances in technologies for mapping power lines and customer connection points (e.g., electrical meters) of an electrical power delivery network.

### SUMMARY

In an aspect, a method may include processing sensor data to detect an electrical utility object. The method may include detecting one or more sub-objects of the electrical utility object. The method may include determining a connection between the one or more sub-objects and another electrical utility object and providing the connection as an output.

In an embodiment, the method may include, performing a topology correction of the connection, the electrical utility object, the one or more sub-objects, the another electrical utility object, or a combination thereof.

In an aspect, a method may include, processing sensor data using a machine learning model to generate one or more electrical utility asset detection instances. The method may include conflating the one or more electrical utility asset detection instances into one or more conflated candidate detections. The method may include performing a particle swarm optimization on the one or more conflated candidate detections to determine a detected electrical utility asset and may include providing the detected electrical utility asset as an output.

In an embodiment, the method may include initiating an electrical utility asset class detection on the one or more conflated candidate detections. The particle swarm optimization may be further based on the electrical utility asset class detection.

In an embodiment, the method may include, generating a training data set comprising one or more electrical utility assets used in a developing country. The machine learning model may be trained to the detect the one or more electrical utility assets of the developing using the training data set.

In an aspect, a method may include, generating a path for a device to capture sensor data depicting one or more objects of an electricity power delivery network. The method may include selecting between a drive device, a drone device, or a combination thereof to complete one or more portions of the path to capture the sensor data. The method may include merging the sensor data from the drive device, the drone device, or a combination thereof on completion of the path. The method may include providing the merged sensor data as an output.

In an embodiment, the path may be generated based on digital map data of a geographic database.

In an embodiment, the method may include, selecting the drone device for the one or more portions of the path associated with an extra-high-tension power line, a high-tension power line, or a combination thereof.

In an embodiment, the output may be used for a consumer indexing, a network creation, or a combination of the electricity power delivery network.

In an embodiment, the method may include, selecting a known ground control point (GCP) as a base point of a virtual GCP layer. The method may include determining a location of the device. The method may include calculating an offset of the location based on the base point to generate a virtual GCP of the virtual GCP layer. The method may include determining a subsequent location of the device. The method may include calculating a subsequent offset of the subsequent location based on the inputting the base point and the virtual GCP to the machine learning model to generate a subsequent GCP of the virtual GCP layer.

In an embodiment, the machine learning model may be a spatio-temporal graph convolutional network (ST-GCN).

In an embodiment, the method may include, determining the designated time period based on a target level of positioning accuracy.

In an embodiment, the subsequent location may be determined using a differential positioning.

In an embodiment, the differential positioning may include real time kinematic (RTK), post processing kinematic (PPK), or a combination thereof.

In an embodiment, the method may include processing sensor data collected by the device to detect a service line associated with an electricity power delivery network. The method may include determining a first geo-position of an endpoint of the service line. The method may include determining a second geo-position of an electrical meter. The method may include determining a distance between the first geo-position of the endpoint and the second geo-position of the electrical meter. The method may include establishing a connection between the service line and the electrical meter based on the distance.

In an embodiment, the method may include performing a consumer indexing of the electricity power delivery network based on the connection.

In an embodiment, the method may include, initiating a detection of a subsequent service line, a subsequent electrical meter, or a combination thereof based on determining that the distance is greater than a threshold distance. The establishing of the connection may be based on the subsequent service line, the subsequent electrical meter, or a combination thereof.

In an embodiment, the method may include evaluating a business heuristic with respect to the service line, the electrical meter, a consumer associated with the electrical meter or a combination thereof. The establishing of the connection may be further based on the business heuristic.

In an embodiment, the processing of the sensor data may include using a machine learning feature detector to classify the service line into a service line type, and wherein the establishing of the connection is based on the service line type.

In an embodiment, the service line type includes a low-tension line, a high-tension line, an extra high-tension line, or a combination thereof.

### BRIEF DESCRIPTION OF THE DRAWINGS

The embodiments of the disclosure are illustrated by way of example, and not by way of limitation, in the figures of the accompanying drawings.

FIG. 1 is an example representation of a system for providing automated integration and networking logic for electrical assets, according to an example embodiment.

FIGS. 2A-2D are examples of electrical service-lines and pole networks, according to an example embodiment.

FIG. 3A is an example representation for providing automated integration and networking logic for electrical assets, according to an example embodiment.

FIGS. 3B-3E are example machine learning outputs for electrical utility asset mapping, according to one embodiment.

FIG. 3F is an example representation of an example connection between electrical utility objects, according to one embodiment.

FIG. 4 is an example representation for an integrated drive and drone sensor data collection system, according to one embodiment.

FIGS. 5A and 5B are example ground control points, according to one embodiment.

FIG. 5C is an example representation for generating virtual ground control points, according to one embodiment.

FIG. 5D is an example virtual ground control point layer, according to one embodiment.

FIG. 6 is an example representation for consumer indexing, according to an example embodiment.

FIG. 7 is a flowchart of an example process for automated creation of electrical grid networks and consumer indexing, according to one embodiment.

FIGS. 8A-8C are example representations of pole networks and/or consumer indexing data, according to various example embodiments.

FIG. 9 is an example representation of a geographic database, according to an example embodiment.

FIG. 10 is a diagram of hardware that can be used to implement an example embodiment of the processes described herein.

FIG. 11 is a diagram of a chip set that can be used to implement an example embodiment of the processes described herein.

FIG. 12 is a diagram of a terminal that can be used to implement an example embodiment of the processes described herein.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional blocks not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

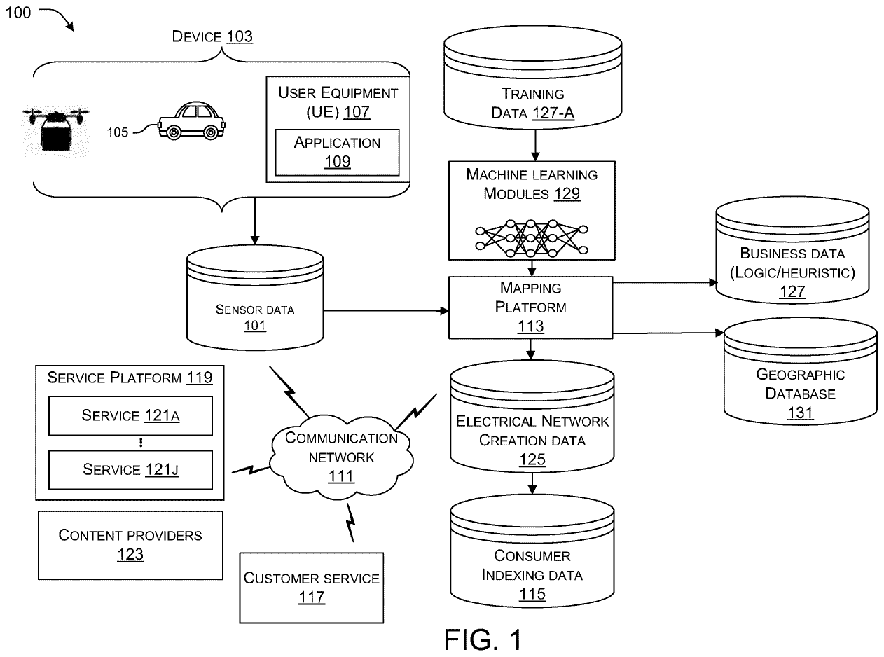

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

Unless the context requires otherwise, throughout the specification and claims which follow, the word “comprise” and variations thereof, such as, “comprises” and “comprising” are to be construed in an open, inclusive sense that is as “including, but not limited to.” As used in this specification and the appended claims, the singular forms “a,” “an,” and “the” include plural referents unless the content clearly dictates otherwise. It should also be noted that the term “or” is generally employed in its broadest sense that is as meaning “and/or” unless the content clearly dictates otherwise.

The headings and Abstract of the disclosure provided herein are for convenience only and do not interpret the scope or meaning of the implementations.

The various embodiments throughout the disclosure will be explained in more detail with reference to FIG. 1- . . .

FIG. 1 is an example representation 100 of a system capable of providing automated integration and networking logic for electrical assets, according to an example embodiment.

Electrical power-line networks or grids are complex networks of power lines extending from power generation sites to the end consumer sites. Generally, electricity in power networks or grids flow from higher voltage lines (e.g., to facilitate long-range transmission) down to lower voltages suitable consumer endpoints. This means, for instance, that power-lines usually go from extra high tension (EHT) lines to high tension (HT) to low tension (LT) lines terminating at electrical meters installed on the premises of electricity consumers.

In summary, the various embodiments described herein relate to automated consumer indexing and network creation from sensor data 101. In one embodiment, a fleet of devices 103, for example, (1) vehicles 105 such as taxi cabs, Original Equipment Manufacturer (OEM) fleets, and/or the like; and (2) user equipment (UE) devices 107 executing location-based applications 109 such as smartphones, portable navigation systems, and/or the like; and drones or other aerial vehicles are equipped with positioning devices or sensors (e.g., Global Positioning System (GPS) or equivalent) which constantly record their positions, heading direction, and current speed at various time intervals (e.g., every 5 seconds) along with other sensor data (e.g., image data) depicting the environment in which they are traveling (e.g., images of environments with overhead power lines). The resulting sensor data 101 consists of location data points, wherein each point may be a tuple (e.g., a tuple of location <latitude—lat, longitude—lon> and heading/speed <time—t, speed—s, heading—h>) indicating that a vehicle 105 or device 107 is at location (lat, lon) at the time the corresponding senor data 101 was captured. At fixed time intervals, the recorded sensor data 101 may be streamed over a communication network 111 to a central server (e.g., a mapping platform 113), which on this basis performs network creation and/or consumer indexing (e.g., electrical network creation data 125 and/or consumer indexing data 115) according to the embodiments described herein. In one embodiment, this information is then provided as a service to customers (e.g., electric company customers, regulatory agencies, etc.). These services, for instance, can be provided by the mapping platform 113 itself or by any other service or application such as, but not limited to, a services platform 119, one or more services 121a-121j of the services platform 119, content providers 123, application 109, and/or the like.

In one embodiment, the machine learning model 129 may be trained based on training data 127-A collected from a specific geographic area (e.g., a city) so that the models 129 may be used specifically for that geographic area or city. Additionally, or alternatively, there is an option of training the models 129 on numerous areas of interest (e.g., different cities) by mixing training data from multiple regions, which may reduce costs for maintaining multiple models 129 and make the models 129 more generalizable to different geographic areas. Further, business data 127-B (logistic/heuristic) may be collected from the mapping platform 113.

Returning to FIG. 1, as shown, the system 100 includes the mapping platform 113 for providing consumer indexing and/or network creation in an electrical power-line network. In one embodiment, the mapping platform 113 includes or is otherwise associated with one or more machine learning models 129 (e.g., neural networks or other equivalent network) for processing input features of the sensor data 101 to identify electrical assets and related electrical network components.

In one embodiment, the mapping platform 113 has connectivity over the communication network 111 to the customer systems 117 and services platform 119 that provides one or more services 121 that can use the electrical network creation data 125 and/or consumer indexing data 115 to perform one or more functions. By way of example, the services 121 may be third party services and include, but is not limited to, mapping services, electric power delivery services, location-based services, etc.

In one embodiment, the mapping platform 113 may be a platform with multiple interconnected components. The mapping platform 113 may include multiple servers, intelligent networking devices, computing devices, components, and corresponding software for combining location data sources according to the various embodiments described herein. In addition, it may be noted that the mapping platform 113 may be a separate entity of the system 100, a part of the services platform 119, a part of the one or more services 121, or included within components of the vehicles 105, UEs 107, drones, and/or other devices 103.

In one embodiment, content providers 123 may provide content or data (e.g., including geographic data, sensor data, etc.) to the geographic database 131, the mapping platform 113, the services platform 119, the services 121, the vehicles 105, the UEs 107, drones, and/or the applications 109 executing on the UEs 107. The content provided may be any type of content such as, but not limited to, machine learning models, map embeddings, map content, textual content, audio content, video content, image content, etc. In one embodiment, the content providers 123 may provide content that may aid in consumer indexing and/or network creation according to the various embodiments described herein. In one embodiment, the content providers 123 may also store content associated with the mapping platform 113, geographic database 131, services platform 119, services 121, and/or any other component of the system 100. In another embodiment, the content providers 123 may manage access to a central repository of data, and offer a consistent, standard interface to data, such as a repository of the geographic database 131.

In one embodiment, the vehicles 105, drones, and/or UEs 107 may execute software applications 109 to provide sensor data 101 and/or other related data for consumer indexing and/or network creation according to the embodiments described herein. By way of example, the applications 109 may also be any type of application that is executable on the vehicles 105 and/or UEs 107 such as, but not limited to, mapping applications, location-based service applications, navigation applications, device control applications, content provisioning services, camera/imaging application, media player applications, social networking applications, calendar applications, and the like. In one embodiment, the applications 109 may act as a client for the mapping platform 113 and perform one or more functions associated with consumer indexing, network creation, or equivalent tasks alone or in combination with the mapping platform 113.

By way of example, the vehicles 105, drones, and/or UEs 107 is or may include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 105, drones, and/or UEs 107 can support any type of interface to the user (such as “wearable” circuitry, etc.).

In one embodiment, the vehicles 105, drones, and/or UEs 107 are configured with various sensors for generating or collecting environmental image data, related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 131. By way of example, the sensors may include a global positioning sensor for gathering location data (e.g., GPS), inertial measurement units (IMUs), a network detection sensor for detecting wireless signals or receivers for different short-range communications (e.g., Bluetooth, wireless fidelity (Wi-Fi), light fidelity (Li-Fi), near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 105 and/or UEs 107 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 105, drones, and/or UEs 107 may detect the relative distance of the device or vehicle from a lane or roadway, the presence of electrical assets. In one scenario, the sensors may detect altitude and/or height data of detected assets. In one embodiment, the vehicles 105, drones, and/or UEs 107 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 111 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

By way of example, the mapping platform 113, services platform 119, services 121, vehicles 105 and/or UEs 107, and/or content providers 123 communicate with each other and other components of the system 100 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

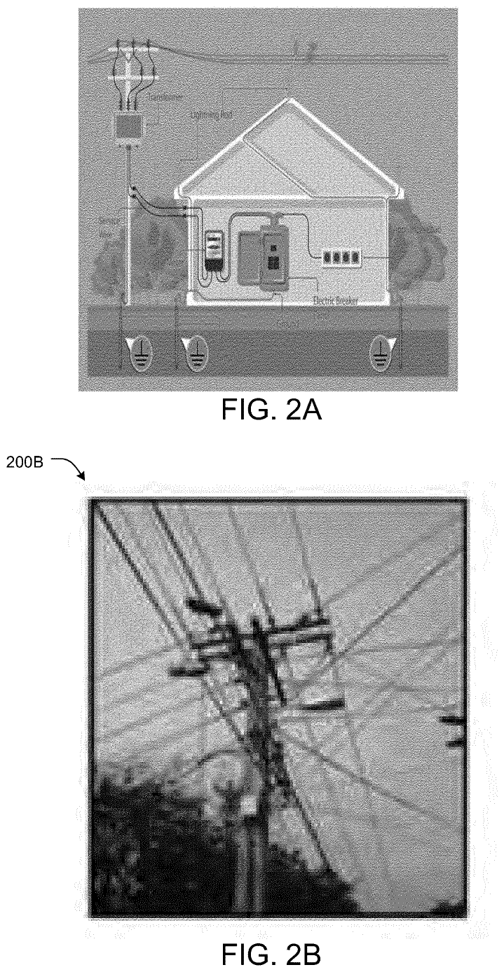

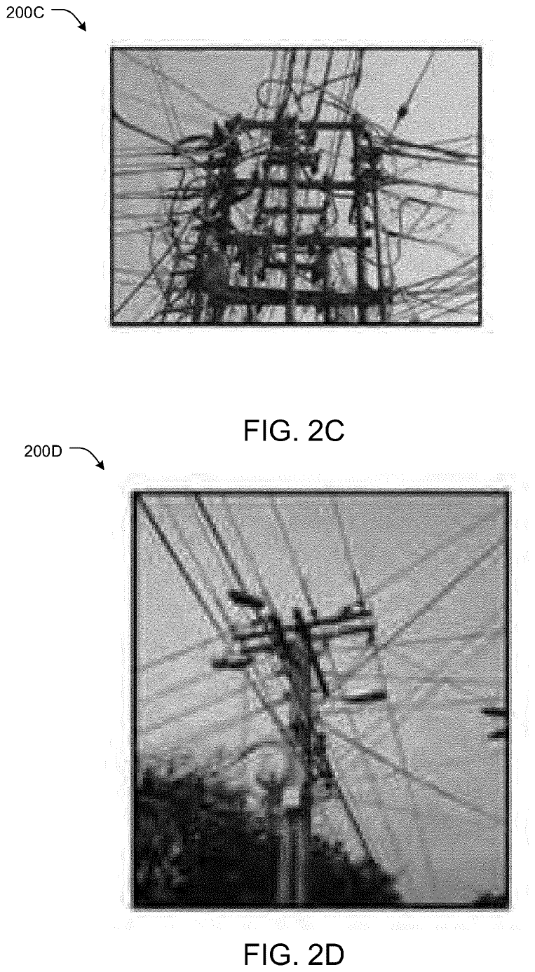

FIG. 2A illustrates an example 200A where an electrical pole is configured with HT tension lines (e.g., higher voltage lines) and LT service lines serving a customer's home, according to one embodiment. As shown, electrical poles are connected to other poles via HT lines for power transmission. By way of example, the HT lines may be mounted to the pole using insulators or equivalent to prevent electrical arcing from the HT lines. In some embodiments, the type, shapes, numbers, and/or other similar features of the insulators or line mounting hardware may be characteristic of HT lines. In addition, HT lines are typically configured at the top or highpoints of the pole for safety, while the LT service lines are mounted lower on the pole to facilitate attachment to the home.

At a pole, the high voltage electricity of the HT lines can be stepped down to lower voltage via a transformer. The lower voltage electricity may then be delivered to a home via a LT service line. Typically, the LT service line is connected to an electric meter that monitors how much power is drawn from the grid to service the home. As part of the connection of the service lines or wires additional electrical assets including, but not limited to, lightning rods, ground rods, electric breaker panels, appliance load sockets, etc. can also be present. In general, poles are connected to each other via HT lines (e.g., to facilitate electrical power transmission), and poles are connected to consumer premises via LT service lines.

Thus, in one embodiment, the electrical power network or grid may be mapped by determining line connections between poles and determining line connections between poles and electrical meters at consumer premises. Such mapping may be used by electricity providers to identify electricity consumers and their connections to the provider's power grid. This, in turn, facilitates proper billing and metering of electricity usage on a consumer-by-consumer basis. As used herein, “consumer indexing” or “consumer mapping” are terms used to define how a consumer receiving electricity is mapped to LT pole through a service line for complete power distribution (e.g., in an overhead power-line type system).

Such consumer indexing may result in improved efficiency and reduction of unmetered or unbilled electricity loss in the power grid. This mapping of the network may also provide for improved smart grid management by providing an increased understanding of electrical power grid assets and their locations. The lack of information or mapping of assets can be particularly acute in rural areas or highly populated areas where there is poor or no markings of different types of lines and/or related electrical assets.

Traditionally, consumer indexing has been performed through manual processes whereby field technicians or surveyors manually identify service lines terminating at consumer premises. For example, some power companies use forms (e.g., hardcopy or application-based forms) where a person will personally visit service locations to manually enter all the connection details (e.g., specific electrical LT pole or service line service a particular meter on a surveyed household). However, the number of households that would have to be manually surveyed can make traditional mapping cost and resource prohibitive, particularly in highly populated areas.

In addition, there are many areas where the number and/or arrangements of power lines on a pole may be complex, numerous, tangled, etc., which can make identifying specific services lines, their endpoints, connections, etc. difficult and prone to error. FIGS. 2B-2D illustrate examples (200B, 200C, 200D) of electrical poles with complex or confusing power lines. The complex tangle of power lines can make distinguishing HT lines from LT service lines challenging such as how HT lines are connected to other poles or how LT service lines are connected to electrical meters. Knowledge of this electrical utility asset mapping is important to ascertain energy theft during energy audit.

To address these technical challenges, the system 100 of FIG. 1 introduces a capability to provide an automated model to detect, position the service lines to a home, and create a network model of consumer indexing using a meta heuristic method for decision making. In one embodiment, the system 100 provides logic for connecting detected utility assets, where the connections are calibrated with positional accuracy and elevation models. In other words, the system also introduces a complex network model to account for elevation and/or positional accuracy models that can be replicated to any similar domain problem across the world. Thus, it is contemplated that although the various embodiments of this complex network model are discussed with respect to determining connectivity between electrical utility assets or objects, the embodiments are also applicable to similar types of networks with interconnected assets.

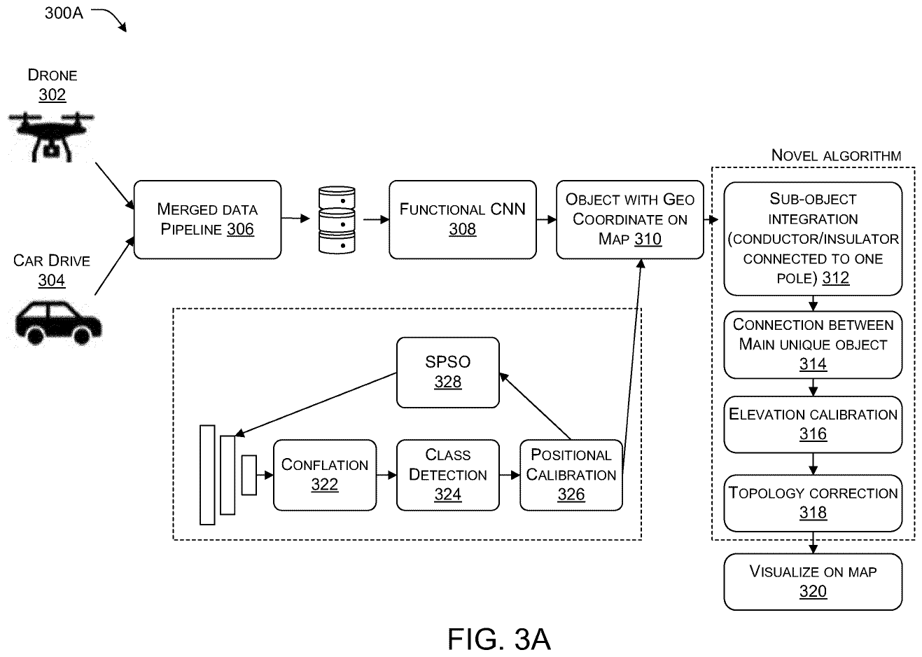

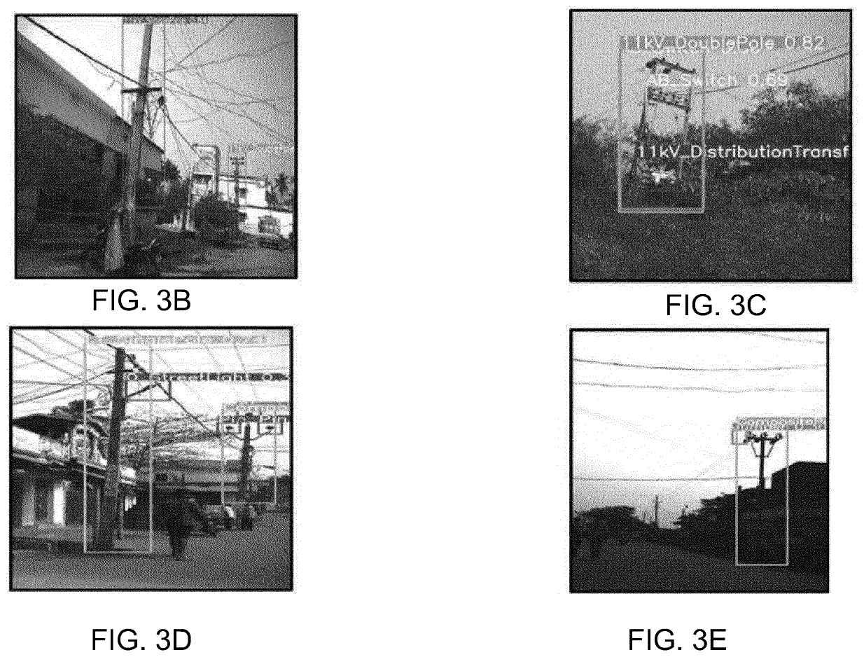

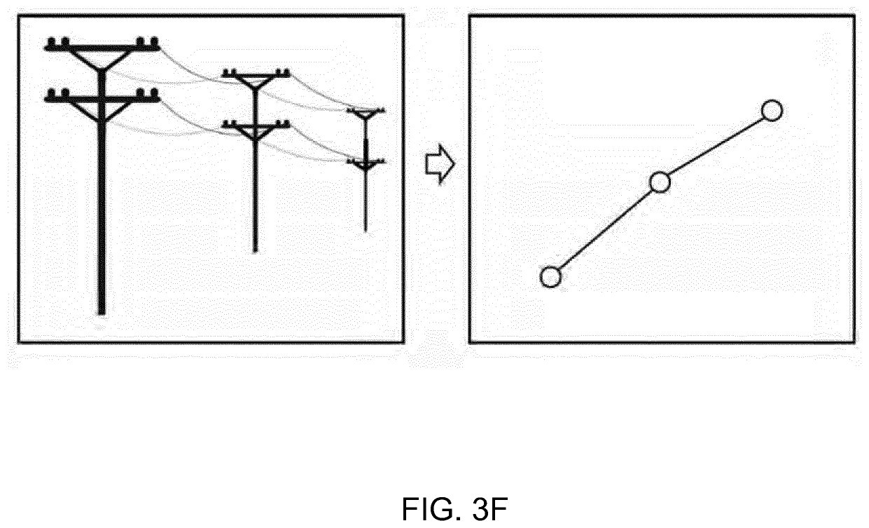

FIG. 3A is an example representation 300A of a solution architecture for providing automated integration and networking logic for electrical assets, according to an example embodiment.

As illustrated in FIG. 3A, data from car drive 302 and drone 304 may be sent to merged data pipeline 306. An output from the merged data pipeline 306 may be provided to a convolutional neural networks (CNN) module 308. Data processed by the CNN module 308 may be sent to an object with geo-coordinate on map module 310. Further, the output form the geo-coordinate on map module 310 may be processed by various modules such as, but not limited to, a sub-object integration module 312, a connect between main unique object module 314, an elevation calibration module 316, a topology correction module 318 to be visualized through a visualize on map module 320.

Further, as illustrated in FIG. 3A, the CNN module 308 may include a conflation module 322, a class detection module 324, a positional calibration module 326, and a stochastic particle swarm optimization (SPSO) module. The output from the merged data pipeline 306 may be processed by the CNN module 308 and provided to the with the geo-coordinate on map module 310 for further processing.

As shown in FIG. 3A, the capture devices (e.g., vehicles 304 and/or drones 302) may collect the images or other sensor data in a merged pipeline 306 for storage for processing by a machine learning model 308 (e.g., CNN or equivalent) that is trained to detect electrical utility assets or objects. The mapping platform may then process the images or sensor data to detect one or more electrical utility objects using the trained machine learning model 308 (e.g., a functional CNN). The geo-coordinates 310 of the detected electrical utility object may then be determined based on the digital map data of a geographic database. For example, the geo-coordinates 310 may be determined based on location tags or metadata associated with the processed imagery or sensor data and then correlated to the digital map data. In another use case where electrical asset locations were previously recorded in the digital map data, the mapping platform may query the digital map for the geo-coordinates of the detected electrical utility asset.

In an embodiment, the mapping platform iteratively performs a particle swarm optimization (e.g., a smart particle swarm optimization (SPSO) or equivalent) on the one or more conflated candidate detections to determine a detected electrical utility asset. By way of example, particle swarm optimization is a computational method that optimizes a problem by iteratively trying to improve a candidate solution with regard to a given measure of quality. It solves a problem by having a population of candidate solutions (e.g., candidate utility asset detections in this case), here dubbed particles, and moving these particles around in the search-space according to simple mathematical formula over the particle's position and velocity. Each particle's movement is influenced by its local best known position but is also guided toward the best known positions in the search-space, which are updated as better positions are found by other particles. This is expected to move the swarm toward the best solutions. The particle swarm optimization process is a meta heuristic algorithm.

After detecting and identifying the electrical utility object(s) of interest and corresponding geo-coordinate data, the mapping platform may additionally detect one or more sub-objects 312 of the main electrical utility object and integrate the detected sub-objects with the main objects. As used herein the term “main” object is an object on which sub-objects are mounted or otherwise associated with. An example of a main object includes an electrical pole, and sub-objects of the pole may include conductor, insulators, and/or any other type electrical utility object connected to, mounted on, or otherwise associated with the pole. During the sub-object integration process, related groups of objects and sub-objects may be grouped together. Examples of electrical utility objects and sub-objects include but are not limited to:
Pin_Insulator
Disc_Insulator
Jumper
CompositePole
AB_Switch
Horn_Gap_Fuse
BusBar
11kV_CTPTUnit
11kV_SinglePole
11kV DoublePole
11kV_TriplePole
11kV_FourPole
11kV_Distribution Transformer
ServiceLine_SinglePole
ServiceLine_DoublePole
0_StreetLight
0_TransmissionTower
0_PSS
33kV_CTPTUnit
33kV_SinglePole
33kV_DoublePole
33kV_TriplePole
33kV_FourPole
33kV_DistributionTransformer
LT_SinglePole
LT_DoublePole

It is noted that any of these objects may be a main object with respect to other objects depending on their spatial arrangements and/or configuration.

After sub-object integration, the mapping platform may determine a connection 314 between the main electrical utility objects and other nearby objects (e.g., connection between one electrical pole and a next or adjacent electrical pole). The connection, for instance, is a wire connecting two different electrical poles (or any other main electrical object). In this example, the poles are the nodes of the electrical network graph and wires connection the poles are the edges of the graph. In one embodiment, the connection 314 may be determined based on detecting a wire in the images or sensor data of the area between two detected poles or other electrical utility objects.

To determine or validate the connection, the mapping platform may also perform an elevation calibration 316 of the connection, the electrical utility object, the one or more sub-objects, another electrical utility object, or a combination thereof. In one embodiment, the elevation calibration 316 refers to normalizing the detected elevation of the electrical objects, sub-objects, connections, etc. to a common frame of reference. In this way, connections that are between objects at the same elevation (or within the same threshold elevation range) may be determined or established. Elevation calibration 316 may also be used to more accurately connect wires or power lines that are mounted at different elevations on an electrical pole. For example, EHT or HT lines may be mounted at the high points of the electrical pole while low tension lines can be mounted lower on the pole. Thus, by calibrating for elevation, wires or powerlines on the same set of poles at different heights can be mapped for network creation.

In addition to elevation calibration 316, the mapping platform may also perform a topology correction 318 of the detected connection, the electrical utility object, the one or more sub-objects, another electrical utility object, or a combination thereof. In one embodiment, the mapping platform may retrieve a terrain elevation map corresponding to the geographic area of the detected electrical objects and then adjust the expected elevations of the objects based on the changes in the terrain. In this way, connections between a pole and other electrical object located on terrain at one elevation may be correlated to connect with a corresponding pole at another location at a different elevation.

FIGS. 3B-3E are example representations of machine learning outputs for electrical utility asset mapping, according to some embodiments. The example images of FIGS. 3B-3E have been processed using embodiments of the solution architecture and the detection results presented in respectively labeled bounding boxes overlaid onto the images.

In one embodiment, the mapping platform may provide the output detection results for consumer indexing and/or electrical network creation, according to the embodiments described below. However, it is noted that the electrical utility asset training data, model, and outputs may be used for any function, service, application, etc. that can use such data. Thus, consumer indexing and network creation are provided by way of illustration and not as limitations.

In one use of the embodiments of the machine learning training model and outputs, the mapping platform may provide an automated model to detect and position electrical utility assets (e.g., service lines to a home) and create a network model of consumer indexing using a meta heuristic method for decision making.

FIG. 3F is an example representation of example connections between electrical utility objects, according to one embodiment. In this example, an image depicting three electrical poles connected with power lines are processed according to the embodiments described herein. Each pole and associated sub-objects (e.g., insulators, etc.) and wires at different elevations and spatial arrangements may be detected and connected according to the logic described above. The determined connections between the detected electrical utility objects can then be visualized on a map user interface as shown.

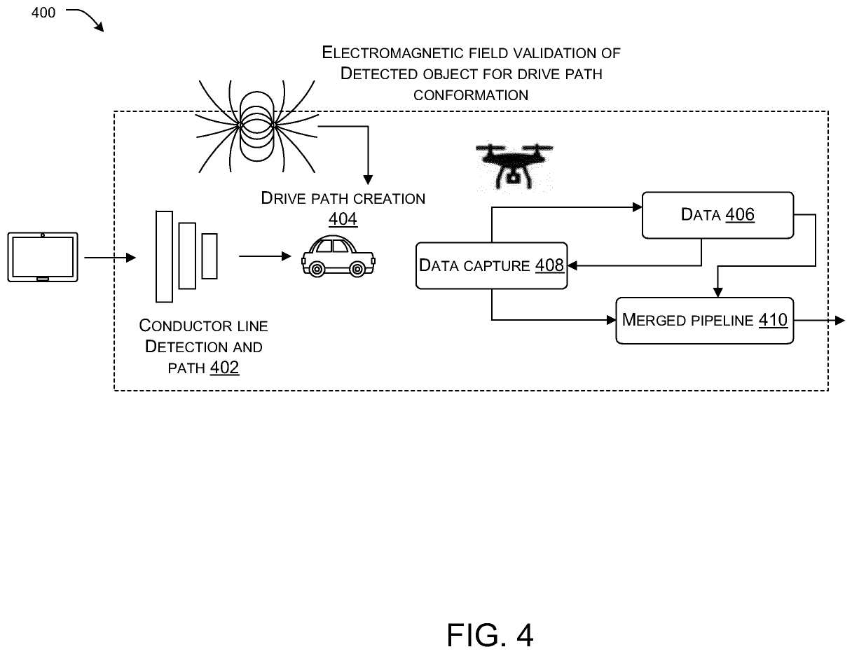

FIG. 4 is an example representation 400 for an integrated drive and drone sensor data collection system, according to one embodiment. In the example of FIG. 3A, the mapping platform selects a geographic area or generates a path (e.g., when digital map data is available of electrical utility assets or objects) to begin surveying. For example, the mapping platform can start with initial images or sensor data indicating the presence of a conductor line and suggests a path based on the conductor line. For example, the mapping platform can use computer vision with trained neural networks or equivalent machine learning models to detect the presence of electrical assets or objects of interest in the sensor data or images. In other words, in one embodiment, the mapping platform generates or suggests a path (or initial starting point of the path) for a device to capture sensor data depicting one or more objects of an electricity power delivery network.

As illustrated in FIG. 4, the solution architecture of an electromagnetic filed validation of detected object for drive path conformation may include a conductor line detection and path 402 followed by a drive path creation 404. Data 406 may be captured and sent to a data capture module 408 for further processing. Finally, the data 406 may be sent to a merged pipeline 410 for further processing.

In one embodiment, the path may be started using a drive device (e.g., a car that is not equipped with HT line detection). Additionally, or alternatively, the mapping platform may select between a drive device, a drone device, or a combination thereof to complete one or more portions of the path to capture the sensor data (e.g., depending on which type of device is can acquire a view of the electrical utility asset or object) to complete one or more portions of the path to capture the sensor data.

In one embodiment, the drive or drone device may include sensors capable of detecting electromagnetic field data of the one or more electrical utility objects. This electromagnetic field data may then be used to confirm that the path. In other words, while imagery may detect visual images of a power line to determine a path to take (e.g., a path following the power lines), there can be potential misidentification of objects that look similar to power lines or wires but are not actually part of the electrical power grid of interest. Accordingly, the presence and/or strength of detected electromagnetic fields associated with the object can indicate that electricity is likely flowing through the wire or power line and thus, the wire or power line is likely to be part of the power grid. The relative strengths of the electromagnetic fields can also indicate the type of wire or power line (e.g., EHT, HT, LT).

In one embodiment, based on the presence of the EHT or HT power lines, the mapping platform can select to use a drone device to survey that portion of the path. This is because electromagnetic field sensors may have to be at a consistent distance from the wire to provide comparable measurements because of the decay of electromagnetic field strength over distance. In some cases, only drones may have sufficient access to high mounted power lines to take a measurement and/or to capture appropriate imagery for processing. On the other hand, drive devices at street level may be selected to capture imagery when LT service lines are present because they are usually mounted lower and are visible from a street level perspective.

The mapping platform can make dynamic decisions regarding what direction to travel in the next portion of the path based on the detected imagery. For example, the path can follow a particular branch of the power line network by following the direction of the line in the captured imagery even when the direction was previously unknown. The mapping platform can also dynamically determine whether a particular portion of the path is best imaged or captured by a drive device or drone device based on characteristics of the detected electrical assets (e.g., presence of EHT vs HT vs LT lines, mounting heights of the electrical utility assets or objects, potential obstructions, device availability, etc.).

In one embodiment, because the captured sensor data or image data can vary between street level and aerial perspectives, the mapping platform can perform calibrations of the sensor data to enable the processing of the data through a merged pipeline. For example, the mapping platform can calibrate a positional accuracy the sensor data, image data, or a combination thereof between the one or more portions of the path traversed by the drive device, and the one or more portions of the path traversed by the drone device. This is because there can be differences in the positional accuracies of geo-locations determined by the drive device and drone device. It is contemplated that any means of calibration can be using including but not limited to: (1) averaging, (2) bundle adjustment, (3) photo stitching to match edges and perspectives, (4) normalizing to a global frame of reference, and/or any other equivalent means.

In another example, the mapping platform can perform calibration of the images captured by the drive and drone devices. This calibration can include normalizing to a consistent resolution or other image characteristics such as, but not limited to, color, contrast, brightness, etc. that is suitable for input into machine learning models used in the merged processing pipeline.

In one embodiment, the sensor data (e.g., image data) generated according to the various embodiments described herein using integrated drive and drone collection system can be used to provide any service, application, or function. One example application is providing an automated model to detect electrical service lines (e.g., based on the merged sensor data or imagery generated by the integrated drive and drone collection system), position the service lines to a home, and create a network model of consumer indexing using a meta heuristic method for decision making.

In one embodiment, devices such as drones or equivalent can include positioning receivers capable of real-time kinematic (RTK) or equivalent technology to make accurate measurements. RTK relies on base stations acting as google cloud platform services (GCPs) from which signals for correcting positioning data are transmitted. GCPs, for instance, are identifiable points (e.g., RTK base station locations) on the Earth's surface that have precise three-dimensional location (e.g., latitude, longitude, and elevation). Traditionally, generating ground control points has been a manual effort that requires deploying ground surveyors to the locations of ground control points to make manual measurements. This traditional approach, however, is labor intensive and does not scale well when available manual resources are limited.

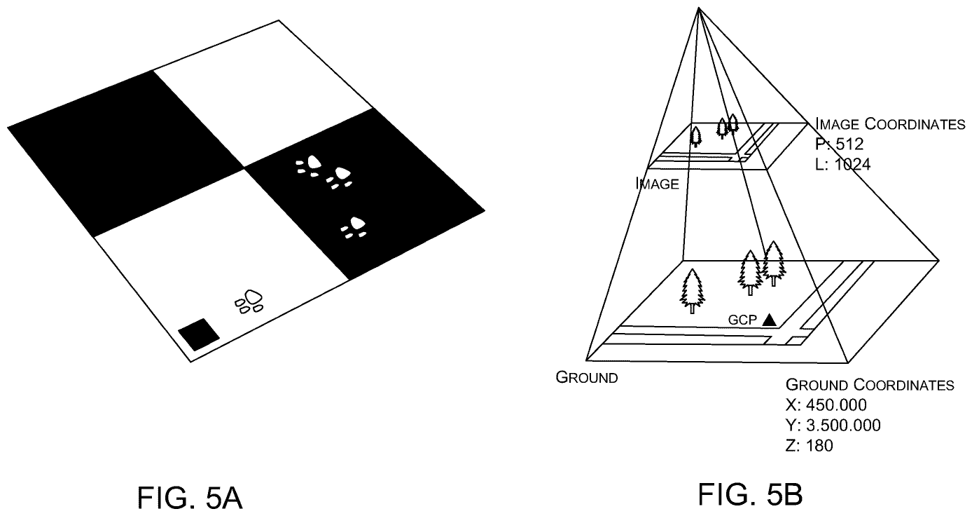

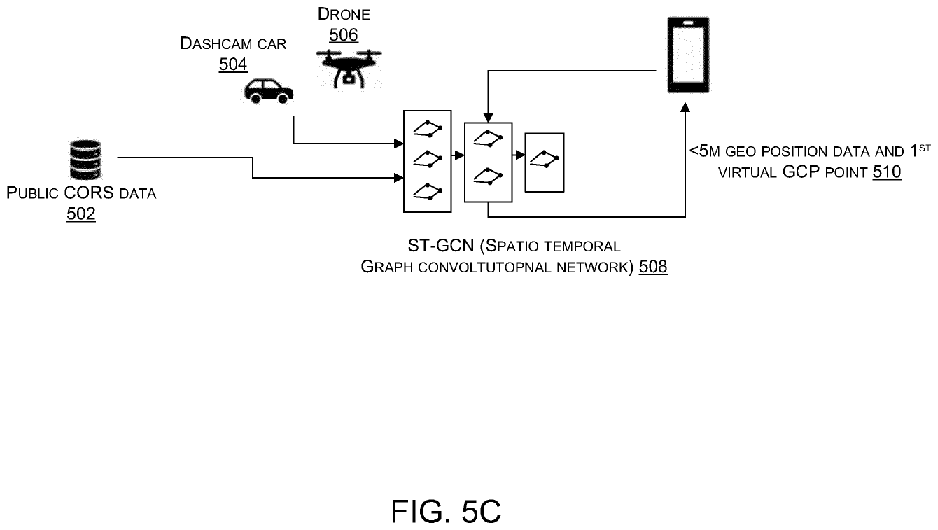

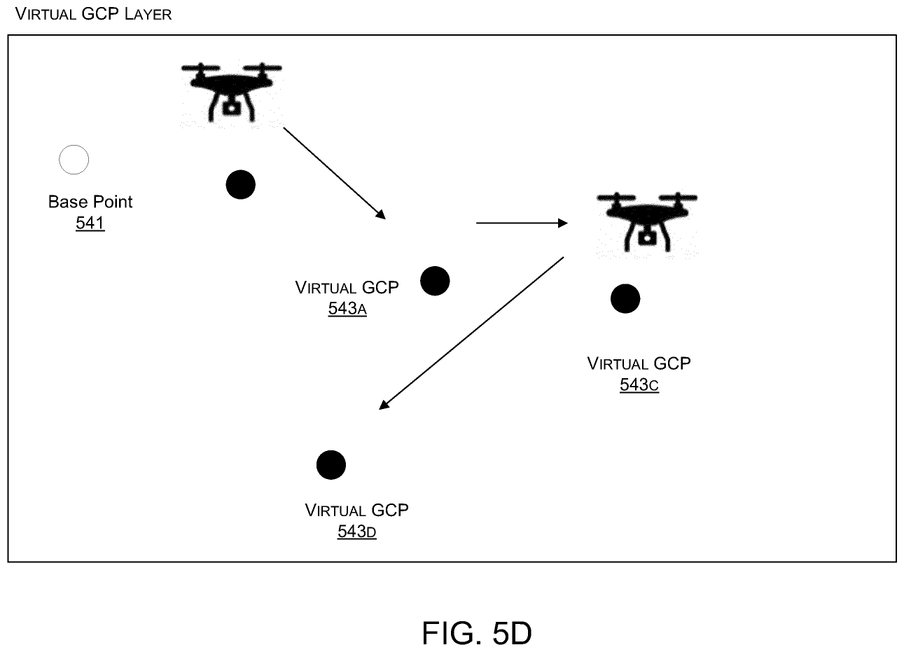

For example, as discussed above, ground control points traditionally are collected by ground surveyors who go out in the field and use instruments like a theodolite, measuring tape, three-dimensional (3D) scanner, satellite-based location sensors (e.g., global positioning system (GPS)/global navigation satellite system (GNSS)), level and rod, etc. to measure the locations of ground control points with respect to the locations of distinguishable landmarks on the Earth (e.g., parts of signs, barriers, buildings, road paint, etc.). FIGS. 5A and 5B illustrate examples (500A, 500B) of GCPs, according to various embodiments. Collecting each ground control point using traditional manual means requires a substantial amount of infrastructure and manual resources. The problems become even more pronounced if the ground control points need to be measured on the road (e.g., for map making use cases) since special access permissions need to be obtained from the government or other responsible authorities. Because of the infrastructure and resource burden, the process of obtaining ground control points using traditional means is not scalable if they need to be used in map making and evaluation process.

To complicate the process further, ground control points are valid for unpredictable periods of time. For example, a previously measure ground control point can become invalid or obsolete if the feature or object on which the ground control point is based changes, for instance, due to construction, paint deterioration, and/or other changes to the environment. Other changes, for instance, can include to shifts in tectonic plates or other geological movements that shift the location of ground control points by a couple of centimeters or more per year. For high-definition map use (e.g., with centimeter level accuracy), those micro changes in ground control points can have an effect on the accuracy of digital maps. Accordingly, map service providers face significant technical challenges to determining ground control points that can scale (e.g., with increased map coverage) given limited available resources and that can be updated at a frequency sufficient to reduce the probability of a ground control point becoming invalid or obsolete below a target threshold.

For example, RTK relies on networks of base stations such as the Continuously Operating Reference Stations (CORS) network operated by the U.S. National Oceanic and Atmospheric Administration. These stations are independently owned and operated, and can be expensive to establish and operate. Accordingly, the available RTK base stations can be relatively sparse, which in turn can limit the availability of the stations for improved positioning accuracy.

In summary, the problems associated with traditional GCPs include:
Very costly to collect GCP using a device on the ground;
All Drive planning is dependent on drive;
Cannot be done for large area;
All RTK, process performance index (PPK) that drone uses is dependent on GCP again to derive its accuracy; and
All the autonomous driving cars, mobile phone, 3rd party advanced driver assistance system (ADAS) compliance need less than 5 m accuracy.

To address these technical challenges, the system 100 of FIG. 1 introduces a capability to generate virtual GCPs using a machine learning model e.g., a spatio-temporal graph convolutional network (ST-GCN) or equivalent based on an initial known GCP (e.g., determined from CORS or equivalent database of GCPs) to fill in sparse GCP data. For example, in one embodiment, the mapping platform can use the publicly available CORS dataset or equivalent and select and known point (e.g., latitude and longitude with a <4 cm accuracy), which will act as a base point of the virtual GCP generation process. The mapping platform can then use a location of one or more devices (e.g., drone and/or drive devices) equipped with positioning sensors (e.g., GPS/GNSS receivers capable of RTK/PPK or equivalent) that is offset by the base point to generate a virtual GCP.

Then, the base point and first virtual GCP can be input into a trained machine learning (e.g., ST-GCN or equivalent) to predict the offset for a next location/GPS point (e.g., collected by a drone equipped with RTK or equivalent) to generate another virtual GCP point. The process can continue by subsequent and iterative input of the additionally generated virtual GCP points (e.g., essentially forming a graph or sequence of the virtual GCPs) until a desired number of virtual GCPs are created. In other words, the mapping platform can use the ST-GCN or equivalent to calculate the offset to apply to each location determined using a drone and/or drive device to increase positioning accuracy to a level comparable to a traditionally surveyed GCP while advantageously avoiding the costs of manually generating GCPs. In one embodiment, the virtual GCPs can be aggregated into a virtual GCP layer (e.g., of a geographic database) for distribution of user devices (e.g., a smartphone). By calculating offsets based on the virtual GCPs, the smartphone can improve positioning accuracy to <5 m permanently which compared to traditional accuracy in the 8 m to 96 m range.

FIG. 5C is an example representation 500 for generating virtual ground control points, according to one embodiment. In the example of FIG. 5C, the mapping platform selects a known GCP (e.g., from the public CORS database or equivalent) as a base point of a virtual GCP layer. Next, the mapping platform determines a location of a device (e.g., a drone, drive device/vehicle, or equivalent). In one embodiment, the device is a drone device that is operated to hover at the location for designated time period to acquire the location (e.g., latitude, longitude, timestamp) of the device. For example, a drone that is equipped with an RTK capable GPS receiver (and/or any other type of PPK or differential positioning receiver) may have to hover for the designated time period to achieve a target level of accuracy. Thus, the mapping platform can determine the designated time period of the drone hover or a drive device to remain stationary based on a target level of positioning accuracy.

As illustrated in FIG. 5C, public CORs data 502 and data from a dashcam car 504, and a drone 506 can be sent to a ST-GCN 508 for processing. The output from the ST-GCN 508 can be obtained as a 5M geo position data and first virtual GCP point 510.

In one embodiment, the location selected as an intersection point of the drive device and a drone device to within a threshold proximity (e.g., intersect within 5-6 m). The intersection point can be determined using either the positioning system of the drive device or drone device.

In one embodiment, the mapping platform can select the location for generating the virtual GCP based on the terrain of the environment. The mapping platform, for instance, can query a digital terrain map of the area and then select the location and/or number/density of the virtual GCPs based on the terrain. For example, if the terrain is relatively flat and consistent with no features that can cause GPS signal obstruction, then fewer virtual GCPs may be needed. On the other hand, in more variable terrain (e.g., hilly or mountainous areas), a higher density of virtual GCPs can be created.

After selecting the location(s), the mapping platform can calculate an offset of the location based on the initial base point (e.g., known GCP from CORS) to generate a virtual GCP. In other words, the starting point of the process offsets a detected location using the based point to improve positioning accuracy. The mapping platform then determines a subsequent location of the device or another device to generate another virtual GCP. However, instead of calculating an offset based on the base point (e.g., the known GCP). The mapping platform can use the base point and first generated virtual GCP as inputs to a trained ST-GCN or equivalent network to predict an offset for the subsequent location to improve the accuracy of the subsequent location. The ST-GCN treats each point (e.g., starting from the base point to subsequently generated virtual GCPs) as a sequence or graph to predict the expected position or offset for the virtual GCP to be generated. In this way, the mapping platform can quickly and inexpensively create any number of virtual GCPs in a virtual GCP layer.

FIG. 5D illustrates an example of a virtual GCP layer including an initial base point 541 (e.g., known GCP from CORS). This base point 541 is used to calculate an offset for virtual GCP 543a (e.g., a location at which an RTK capable drone has hovered from 10 mins). The base point 541 and virtual GCP 543a is input as an initial input to a trained ST-GCN to predict the offset for the next location at which the drone hover to generate 543b. The base point 541 and virtual node 543a-b can be used as graph nodes of an input to the ST-GCN to predict the next offset to generate virtual GCP 543c. The base point 541 and virtual GCPs 543a-c are then provided graph nodes of an input to the ST-GCN to predict the offset for generating a virtual GCP.

In one embodiment, the virtual GCP layer is provided as an output for any number of uses or functions. For example, the output can be used by mobile devices to improve positioning accuracy. This improved positioning accuracy can be used for improved mapping, navigation, and/or other location-based services. For example, in the context electrical power grid mapping and consumer indexing, the improved positioning accuracy can improve mapping and consumer indexing results particular in highly populated or building dense areas. This consumer indexing and electrical network creation use case is illustrated below.

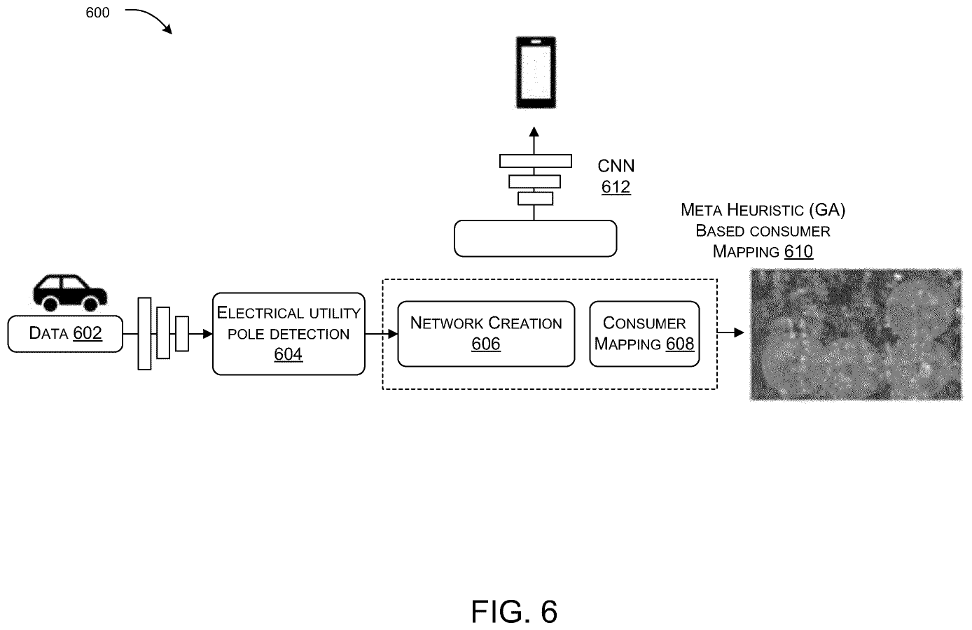

In one embodiment, the automated integration and network logic can be used for network creation and consumer indexing as shown in FIG. 6. The example architecture 600 of FIG. 6 (e.g., based on components as illustrated in FIG. 1) can include data collection devices (e.g., vehicles, drones, and/or other mobile devices such as smartphones) that can capture sensor data (e.g., image data) via onboard sensors (e.g., camera sensors) while traveling on routes where power lines, poles, and/or other electrical power grid assets (e.g., meters, transformers, insulators, circuit breakers, etc.) are present.

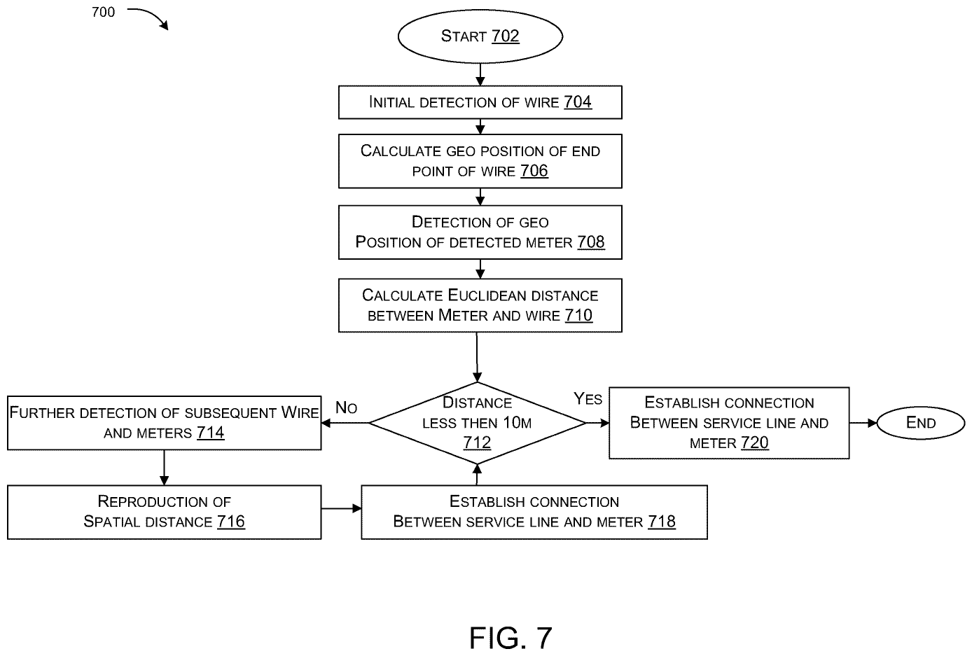

As illustrated in FIG. 6, data 602 and information based on an electrical utility pole detection 604 can be processed by a network creation module 606 and a consumer mapping module 608 to generate an output with meta heuristic-based consumer mapping 610. Further, the output with the meta heuristic-based consumer mapping 610 may be processed by a CNN module 612. In one embodiment, the system 100 can use the meta heuristic-based consumer mapping process as described in more detail with respect to FIG. 7.

FIG. 7 is a flowchart of a process 700 for automated creation of electrical grid networks and consumer indexing, according to one embodiment. In various embodiments, the mapping platform and/or any of its modules may perform one or more portions of the process and may be implemented in, for instance, a chip set including a processor and a memory. As such, the mapping platform 113 of FIG. 1 and/or any of its modules can provide means for accomplishing various parts of the process, as well as means for accomplishing embodiments of other processes described herein in conjunction with other components of the system 100. Although the process is illustrated and described as a sequence of steps, it is contemplated that various embodiments of the process may be performed in any order or combination and need not include all of the illustrated steps.

As illustrated in FIG. 7, the following steps may be used.
At step 702: The process can be initiated.
At step 704: The mapping platform can perform an initial detection of wire.
At step 706: Geo position an end point of wire can be calculated by the mapping platform.
At step 708: Geo position of a detected meter can be detected by the mapping platform.
At step 710: Euclidean distance between meter and wire can be calculated by the mapping platform.
At step 712: The mapping platform can determine if distance is less than 10 meters.
At step 714: Based on a positive determination from step 710, the mapping platform can perform detection of subsequent wire and meters.
At step 716: Further, the mapping platform can perform a reproduction of a spatial distance.
At step 718: The mapping platform can establish connection between service line and meter and further continue with step 712.
At step 720: Based on a positive determination from step 710, the mapping platform can establish a connection between service line and meter.
At step 723: The process can be terminated.

In the first step, the mapping platform performs an initial detection of wire associated with electrical power lines. In one embodiment, devices (e.g., vehicles, drones, mobile devices, and/or equivalent) can capture sensor data (e.g., image data or any other type of sensor data such as, but not limited to, magnetometers to detect magnetic fields associated with live wires) to identify wires or power lines of an electrical power delivery network or power grid. For example, as described above, a machine learning-based object or feature detector (e.g., a trained CNN) can be used to detect wires or power lines depicted in images captured by the devices. In other words, the mapping platform processes sensor data collected by a device to detect a service line or wire associated with an electricity power delivery network. In one embodiment, the detection of the wire or power line can include classifying the type of the wire (e.g., EHT, HT, LT, etc.) so that the system can determine which wire is more likely to be connected directly to a corresponding meter at a consumer premises (e.g., LT service lines are generally connected to the meter). Examples of image data to process for detecting wires are illustrated in the examples of FIGS. 2A-2D above.

Next, the mapping platform calculates the geo-position (e.g., latitude, longitude, and/or height/altitude) of the endpoint of the wire or service line. In one embodiment, the endpoint of the wire or power line corresponds to the connection of the wire or powerline to a corresponding electrical pole. By way of example, the mapping platform can determine the geo-position of the endpoint of the wire, service line, or power line based on positioning data tagged in the image or sensor data processed to detect the wire. For example, the device capturing the image or sensor data can also determine its geo-location (e.g., via GPS or other positioning sensor/technology) at the time the sensor data was captured or otherwise acquired. The reported sensor data can then be tagged or otherwise associated with the geo-location.

Next, the mapping platform can detect or otherwise determine the geo-position of an electrical meter of interest (e.g., as detected or selected by the mapping platform). In one embodiment, the meter and its geo-position can be detected based on a database of known meters. In addition, or alternatively, the meter can be detected using computer vision and/or processing of image data if the meter is visible on the outside of a consumer house or premises.

The mapping platform then determines a distance between the geo-position of the endpoint of the wire and the geo-position of the electrical meter. For example, the mapping platform can calculate a Euclidean distance (or any other type of distance metric) between the meter and the wire.

In one embodiment, the mapping platform can establish a connection between the service line or wire and the electrical meter based on the distance. For example, if the calculated distance is less than a designated threshold value (e.g., 10 meters or any other selected threshold), the mapping platform can determine that there is a connection between the service line and the electrical meter. In other words, the mapping platform determines that the electrical meter is served electricity by the identified service line or wire.

However, if the calculated distance is greater than the designated threshold (e.g., 10 meters or any other selected value), then mapping platform can initiate further detection of subsequent wires/service lines and/or electrical meters. For example, the mapping platform can obtain sensor data or imagery from nearby locations to determine whether there are other electrical poles/wire endpoints or meters that are candidates for matching against the previously detected endpoint and/or electrical meter. The mapping platform can initiate reproduction of the spatial distances for the subsequently detected service lines, endpoints, and/or meters (i.e., calculate respective Euclidean distances between the subsequent detections) to determine whether the new distances are within the distance threshold. If so, the connection can be established between the detected poles and/or detected service lines and electrical meters.

In this way, network creation can be performed to map connections between poles (e.g., to facility network creation) as well as between service lines and electrical meters (e.g., to facilitate or perform consumer indexing of the electricity power delivery network based on the established connection(s)).

In one embodiment, the mapping platform can use business logic and/or other heuristics to establish or validate identified connections. For example, if there are multiple poles or service line endpoints within the designated threshold distance of an electrical meter, the business logic or heuristic can be used to determine which of the poles or endpoints is likely to be the best match. Even if there is only one pole or service line endpoint within a distance threshold, the business logic or heuristic can be used to determine the confidence level that the established connect is correct. In other words, the mapping platform can evaluate a business heuristic with respect to the service line, the electrical meter, a consumer associated with the electrical meter or a combination thereof. The establishing of the connection is further based on or validated using the business heuristic.

One example of a business heuristic is based on an electricity loss on the service line to the electrical meter. For example, the mapping platform or electric company may know the electricity loss or usage on the service line. This electricity loss value can then be used to determine whether the loss or usage is compatible with the established connection. For example, if a service line endpoint has established connections to four different electrical meters, the analysis is would be whether the detected electricity loss is compatible with four potential electricity users.

Another example of a business heuristic is based on a detection of a branching of the service line towards the electrical meter. For example, the mapping platform can process the sensor data or imagery of the service line to determine whether the direction of the service branches in the direction of the location of the electrical meter. If computer vision shows that the service line or wire branches to the left of the picture while the actual location of the electrical meter is to the right, then the likelihood of a connection may be low.

Another example of a business heuristics is based on customer relationship management (CRM) data associated with the consumer associated with the detected electrical meter. For example, the mapping platform or electric company may query its customer database to determine whether it has a customer at the particular location that may correspond to the location of the wire endpoint or electrical meter. Other CRM information as length of service, type of service, past electricity usage, etc. may also be used for validation or establishing of the connection between a particular wire endpoint and electrical meter.

It is noted that the examples of business heuristics described above are provided by way of illustration and not as limitations. It is contemplated that any similar or equivalent business logic or heuristic based on additional data or information about the wire, meter, associated customer, etc. can be used according to the embodiments described herein.

As noted above, the output of the mapping platform for consumer indexing and/or network creation can be based on the connections determined according to the process 700 of FIG. 7. The output can be used to create a map of the network or index and stored in a geographic database, a map layer of the geographic database, and/or any other equivalent data store. For example, the mapping platform can generate a digital map representation of the established connection(s) and provide the digital map representation as an output.

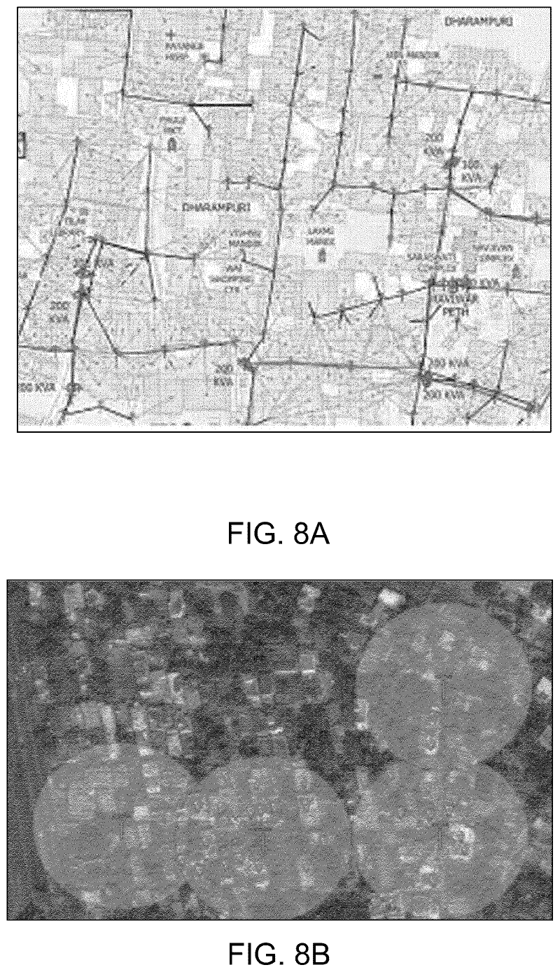

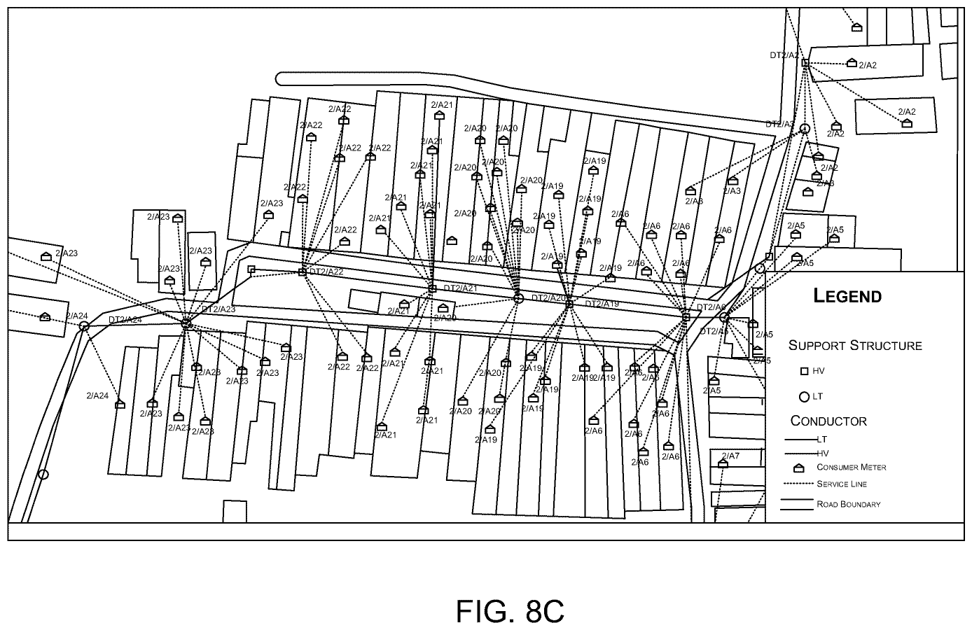

FIGS. 8A-8C are example representations of the consumer indexing data and/or network creation data, according to embodiments of the present disclosure. For example, FIG. 8A illustrates the traditional link-node representation of the electrical power line network and consumer index. In this example, each connection point or node corresponds to an electrical pole, and the wire connecting the poles are represented as links between the poles. In addition, each electrical meter is represented as a sub node of the pole node connected by respective links corresponding to the service lines from the poles.

FIG. 8B illustrates an example representation where each pole or service line endpoint is represented by a “T” symbol and the circle around each pole represents the designated distance threshold for establishing a connection with nearby electrical meters (represented by a lightbulb symbol). Then the connection between each electrical meter (i.e., lightbulb) is represented as an arrow pointing towards the corresponding pole or service line endpoint.

FIG. 8C illustrates an example of overlaying the network creation and consumer indexing data on building footprints on a map. In this example, the representation also distinguishes between HT (or high voltage) and LT service lines. As shown, HT/HV lines (represented by a heavy solid line) connect poles or service line endpoints, and LT lines (represented by a dashed line) connect service line endpoints and consumer meters. Additional cartographic features such as road boundaries are also shown along with building footprints.

It is noted that the example representations of the consumer indexing and network creation data depicted in FIGS. 8A-8C are provided by way of illustration and not as limitations. It is contemplated that any equivalent or other type of representation can be used according to the embodiments described herein.

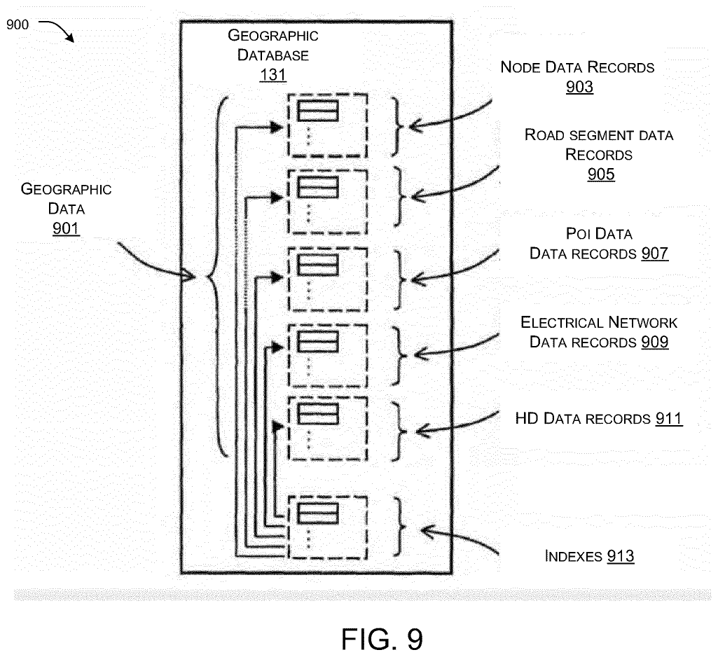

FIG. 9 is an example representation 900 of a geographic database 131, according to one embodiment. In one embodiment, the geographic database 131 includes geographic data 901 used for (or configured to be compiled to be used for) mapping and/or navigation-related services, such as for providing map embedding analytics according to the embodiments described herein. For example, the map data records stored herein can be used to determine the semantic relationships among the map features (e.g., electrical assets), attributes, categories, etc. represented in the geographic data 901. In one embodiment, the geographic database 131 include high definition (HD) mapping data that provide centimeter-level or better accuracy of map features. For example, the geographic database 131 can be based on Light Detection and Ranging (LiDAR) or equivalent technology to collect billions of 3D points and model road surfaces and other map features down to the number lanes and their widths. In one embodiment, the HD mapping data (e.g., HD data records 911) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 131.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 131 follows certain conventions. For example, links do not cross themselves and do not cross each other except at a node. Also, there are no duplicated shape points, nodes, or links. Two links that connect each other have a common node. In the geographic database 131, overlapping geographic features are represented by overlapping polygons. When polygons overlap, the boundary of one polygon crosses the boundary of the other polygon. In the geographic database 131, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 131 includes node data records 903, road segment or link data records 905, POI data records 907, electrical network data records 909, HD mapping data records 911, and indexes 913, for example. More, fewer, or different data records can be provided. In one embodiment, additional data records (not shown) can include cartographic (“carto”) data records, routing data, and maneuver data. In one embodiment, the indexes 913 may improve the speed of data retrieval operations in the geographic database 131. In one embodiment, the indexes 913 may be used to quickly locate data without having to search every row in the geographic database 131 every time it is accessed. For example, in one embodiment, the indexes 913 can be a spatial index of the polygon points associated with stored feature polygons.

In exemplary embodiments, the road segment data records 905 are links or segments representing roads, streets, or paths, as can be used in the calculated route or recorded route information for determination of one or more personalized routes. The node data records 903 are end points (for example, representing intersections or an end of a road) corresponding to the respective links or segments of the road segment data records 905. The road link data records 905 and the node data records 903 represent a road network, such as used by vehicles, cars, and/or other entities. Alternatively, the geographic database 131 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 131 can include data about the POIs and their respective locations in the POI data records 907. The geographic database 131 can also include data about places, such as cities, towns, or other communities, and other geographic features, such as bodies of water, mountain ranges, etc. Such place or feature data can be part of the POI data records 907 or can be associated with POIs or POI data records 1007 (such as a data point used for displaying or representing a position of a city).

In one embodiment, the geographic database 131 can also include electrical network data records 909 for storing electrical network creation data, consumer indexing data, machine learning models (e.g., trained and untrained), embedding layers extracted from trained machine learning models, and/or any other related data that is used or generated according to the embodiments described herein. By way of example, the electrical network data records 909 can be associated with one or more of the node records 903, road segment records 905, and/or POI data records 907 to associate the electrical network data records 909 with specific places, POIS, geographic areas, and/or other map features. In this way, the electrical network data records 909 can also be associated with the characteristics or metadata of the corresponding records 903, 905, and/or 907.

In one embodiment, as discussed above, the high density (HD) mapping data records 911 model road surfaces and other map features to centimeter-level or better accuracy. The HD mapping data records 911 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 911 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 911 are created from high-resolution 3D mesh or point-cloud data generated, for instance, from light detection and ranging (LiDAR)-equipped vehicles. The 3D mesh or point-cloud data are processed to create 3D representations of a street or geographic environment at centimeter-level accuracy for storage in the HD mapping data records 911.

In one embodiment, the HD mapping data records 911 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 131 can be maintained by the content provider in association with the services platform (e.g., a map developer). The map developer can collect geographic data to generate and enhance the geographic database 131. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 131 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles and/or UEs. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

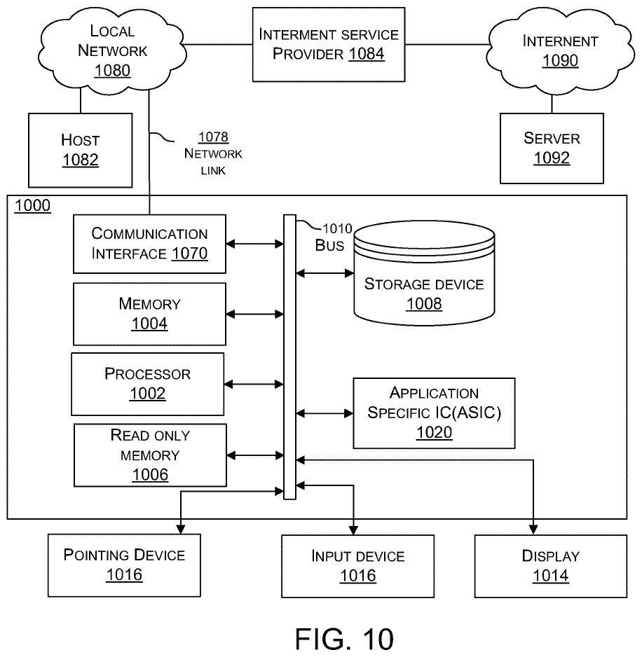

FIG. 10 illustrates a computer system 1000 upon which an embodiment of the disclosure may be implemented. Computer system 1000 is programmed (e.g., via computer program code or instructions) to provide consumer indexing and/or network creation in an electrical power-line network as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to providing consumer indexing and/or network creation in an electrical power-line network. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random-access memory (RAM) or other dynamic storage device, stores information including processor instructions for providing consumer indexing and/or network creation in an electrical power-line network. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing consumer indexing and/or network creation in an electrical power-line network, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general, the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network for providing consumer indexing and/or network creation in an electrical power-line network.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a programmable read only memory (PROM), an erasable PROM (EPROM), a FLASH-EPROM, any other memory chip or cartridge, a carrier wave, or any other medium from which a computer can read.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 10784 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system can be deployed in various configurations within other computer systems.

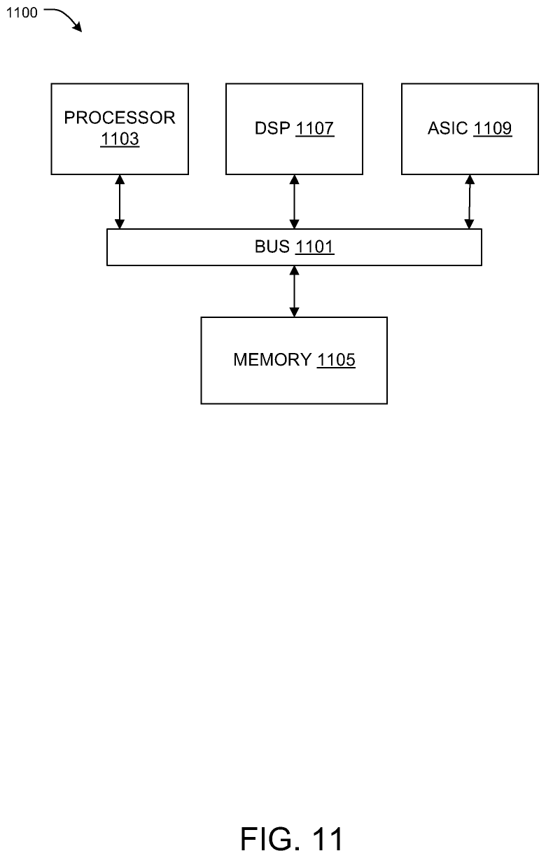

FIG. 11 illustrates a chip set 1100 upon which an embodiment of the disclosure may be implemented. Chip set 1100 is programmed to provide consumer indexing and/or network creation in an electrical power-line network as described herein and includes, for instance, the processor and memory components incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide consumer indexing and/or network creation in an electrical power-line network. The memory 1105 also stores the data associated with or generated by the execution of the inventive steps.

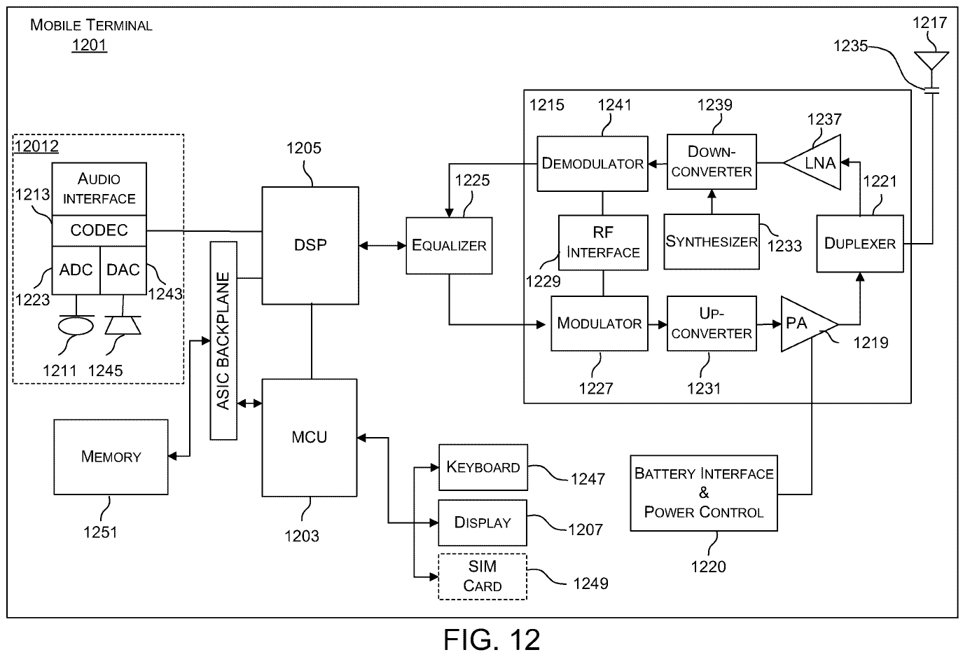

FIG. 12 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile station functions that offer automatic contact matching. An audio function circuitry 1209 includes a microphone 1211 and microphone amplifier that amplifies the speech signal output from the microphone 1211. The amplified speech signal output from the microphone 911 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile station 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a power amplifier (PA) 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile station 1201 to provide consumer indexing and/or network creation in an electrical power-line network. The MCU 1203 also delivers a display command and a switch command to the display 1207 and to the speech output switching controller, respectively. Further, the MCU 1203 exchanges information with the DSP 1205 and can access an optionally incorporated subscriber identity module (SIM) card 1249 and a memory 1251. In addition, the MCU 1203 executes various control functions required of the station. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile station 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1251 may be, but not limited to, a single memory, CD, DVD, ROM, RAM, EEPROM, optical storage, or any other non-volatile or non-transitory storage medium capable of storing digital data.

An optionally incorporated SIM card 1249 carries, for instance, important information, such as the cellular phone number, the carrier supplying service, subscription details, and security information. The SIM card 1249 serves primarily to identify the mobile station 1201 on a radio network. The card 1249 also contains a memory for storing a personal telephone number registry, text messages, and user specific mobile station settings.

While the disclosure has been described in connection with a number of embodiments and implementations, the disclosure is not so limited but covers various obvious modifications and equivalent arrangements, which fall within the purview of the appended claims. Although features of the disclosure are expressed in certain combinations among the claims, it is contemplated that these features can be arranged in any combination and order.

1. A method, comprising:
processing sensor data to detect an electrical utility object;
detecting one or more sub-objects of the electrical utility object;
determining a connection between the one or more sub-objects and another electrical utility object; and
providing the connection as an output.

2. The method of claim 1, further comprising:
performing a topology correction of the connection, the electrical utility object, the one or more sub-objects, the another electrical utility object, or a combination thereof.

3. A method, comprising:
processing sensor data using a machine learning model to generate one or more electrical utility asset detection instances;
conflating the one or more electrical utility asset detection instances into one or more conflated candidate detections;
performing a particle swarm optimization on the one or more conflated candidate detections to determine a detected electrical utility asset; and
providing the detected electrical utility asset as an output.

4. The method of claim 3, further comprising:
initiating an electrical utility asset class detection on the one or more conflated candidate detections,
wherein the particle swarm optimization is further based on the electrical utility asset class detection.

5. The method of claim 3, further comprising:
generating a training data set comprising one or more electrical utility assets used in a developing country,
wherein the machine learning model is trained to the detect the one or more electrical utility assets of the developing using the training data set.

6. A method, comprising:
generating a path for a device to capture sensor data depicting one or more objects of an electricity power delivery network;
selecting between a drive device, a drone device, or a combination thereof to complete one or more portions of the path to capture the sensor data;
merging the sensor data from the drive device, the drone device, or a combination thereof on completion of the path; and
providing the merged sensor data as an output.

7. The method of claim 6, wherein the path is generated based on digital map data of a geographic database.

8. The method of claim 6, further comprising:
selecting the drone device for the one or more portions of the path associated with an extra-high-tension power line, a high-tension power line, or a combination thereof.

9. The method of claim 6, wherein the output is used for a consumer indexing, a network creation, or a combination of the electricity power delivery network.

10. The method of claim 6, further comprising:
selecting a known ground control point (GCP) as a base point of a virtual GCP layer;
determining a location of the device;
calculating an offset of the location based on the base point to generate a virtual GCP of the virtual GCP layer;
determining a subsequent location of the device; and
calculating a subsequent offset of the subsequent location based on the inputting the base point and the virtual GCP to the machine learning model to generate a subsequent GCP of the virtual GCP layer.

11. The method of claim 10, wherein the machine learning model is a spatio-temporal graph convolutional network (ST-GCN).

12. The method of claim 10, further comprising:
determining the designated time period based on a target level of positioning accuracy.

13. The method of claim 10, wherein the subsequent location is determined using a differential positioning.

14. The method of claim 13, wherein the differential positioning comprises real time kinematic (RTK), post processing kinematic (PPK), or a combination thereof

15. The method of claim 6, further comprising:
processing sensor data collected by the device to detect a service line associated with an electricity power delivery network;
determining a first geo-position of an endpoint of the service line;
determining a second geo-position of an electrical meter;
determining a distance between the first geo-position of the endpoint and the second geo-position of the electrical meter; and
establishing a connection between the service line and the electrical meter based on the distance.

16. The method of claim 15, further comprising:
performing a consumer indexing of the electricity power delivery network based on the connection.

17. The method of claim 15, further comprising:
initiating a detection of a subsequent service line, a subsequent electrical meter, or a combination thereof based on determining that the distance is greater than a threshold distance,
wherein the establishing of the connection is based on the subsequent service line, the subsequent electrical meter, or a combination thereof.

18. The method of claim 15, further comprising:
evaluating a business heuristic with respect to the service line, the electrical meter, a consumer associated with the electrical meter or a combination thereof,
wherein the establishing of the connection is further based on the business heuristic.

19. The method of claim 15, wherein the processing of the sensor data comprises using a machine learning feature detector to classify the service line into a service line type, and wherein the establishing of the connection is based on the service line type.

20. The method of claim 19, wherein the service line type includes a low-tension line, a high-tension line, an extra high-tension line, or a combination thereof.
